(19) United States
(12) Patent Application Publication
(10) Pub. No.: US 2010/0318759 A1
(43) Pub. Date: Dec. 16, 2010

(54) DISTRIBUTED RDC CHUNK STORE

(75) Inventors: James R. Hamilton, Bellevue, WA (US); Elissa E. S. Murphy, Seattle, WA (US); Navjot Virk, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/484,548

(22) Filed: Jun. 15, 2009

(51) Int. Cl. G06F 12/02

(52) U.S. Cl. 711/171; 711/E12.002

(57) ABSTRACT

The claimed subject matter provides a system and/or a method that facilitates differential transfer and storage of data for network-based backup architectures. A differential compression component can segment a portion of backup information into one or more blocks. In addition, signatures can be generated for each of the one or more blocks. The differential compression component can identify unique blocks from the one or more blocks based upon the generated signatures and signatures of chunks stored in a distributed chunk store. Moreover, a storage component can transfer the unique blocks of the portion of backup information to the distributed chunk store once identified.

### BACKGROUND

As computing devices become more prevalent and widely used among the general population, the amount of data generated and utilized by such devices has rapidly increased. For example, recent advancements in computing and data storage technology have enabled even the most limited form-factor devices to store and process large amounts of information for a variety of data-hungry applications such as document editing, media processing, and the like. Further, recent advancements in communication technology can enable computing devices to communicate data at a high rate of speed. These advancements have led to, among other technologies, the implementation of distributed computing services that can, for example, be conducted using computing devices at multiple locations on a network. In addition, such advancements have enabled the implementation of services such as network-based backup, which allow a user of a computing device to maintain one or more backup copies of data associated with the computing device at a remote location on a network.

Existing system and/or data backup solutions enable a user to store backup information in a location and/or media separate from its original source. Thus, for example, data from a computing device can be backed up from a hard drive to external media such as a tape drive, an external hard drive, or the like. However, in an implementation of network-based backup and/or other solutions that can be utilized to provide physically remote locations for storing backup data, costs and complexity associated with transmission and restoration of user data between a user machine and a remote storage location can substantially limit the usefulness of a backup system. For example, in the case where backup data is stored at a remote network location, data associated with respective versions of an original copy of a file and/or system image can be transmitted to remote storage, where the respective versions can later be retrieved for restoration. However, a sizeable amount of data is generally transmitted over the network in such an example, thereby consuming expensive bandwidth. In addition, high latency times and long delays can accompany transmission of large amounts of data. In the case of restoration of priority devices from backups, high latency can generate further opportunity costs.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methodologies that facilitate efficient transfer and storage for network-based backup architectures. When data is committed to a backup system, a differential based analysis can be performed. For example, remote differential compression techniques can be utilized to reduce data transfer amounts and/or implement de-duplication. In one aspect, the data is segmented into a set of blocks. A signature can be generated for each block. The signatures can be utilized to query an index or metadata associated with a distributed chunk store of the backup system. Blocks with signatures corresponding to positive results of the query need not be transferred to the distributed chunk store as identical blocks already exist.

In accordance with another aspect, a hybrid backup architecture can be employed wherein backup data and/or blocks of backup data can be retained on a global location within a network or internetwork (e.g., a “cloud”) as well as one or more peers. Accordingly, some or all blocks can be obtained from either the cloud or a nearby peer, thus reducing latency and bandwidth consumption associated with restore operations. In one example, selection of locations to be utilized for storing and/or retrieving backup information (e.g., backup versions) can be selected in an intelligent and automated manner based on factors such as, but not limited to, availability of locations, network topology, location resources, or so on.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an example system that utilizes differential compression techniques in a distributed backup storage solution in accordance with various aspects.

FIG. 2 illustrates a block diagram of an example system that identifies chunks of a file or other data stored in a distributed data store in accordance with various aspects.

FIG. 3 illustrates a block diagram of an example system that generates a set of signatures from a file in accordance with one or more aspects.

FIG. 4 illustrates a block diagram of an example system that transfers unique portions of a file or other data to a distributed data store in accordance with various aspects.

FIG. 5 illustrates a block diagram of an example system that implements hybrid cloud-based and peer-to-peer backup storage in accordance with various aspects.

FIG. 6 illustrates a block diagram of an example system that facilitates conducting a differential restore in a hybrid cloud-based and peer-to-peer backup architecture in accordance with various aspects.

FIG. 7 illustrates a block diagram of an example system that facilitates differential transfer and storage of data in a distributed data store in accordance with various aspects.

FIG. 8 illustrates an exemplary methodology for performing differential transfers of backup information in a backup system in accordance with various aspects.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “cloud,” “peer,” “super peer,” “client,” and the like are intended to refer to a computer-related entity, either hardware, software in execution on hardware, and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

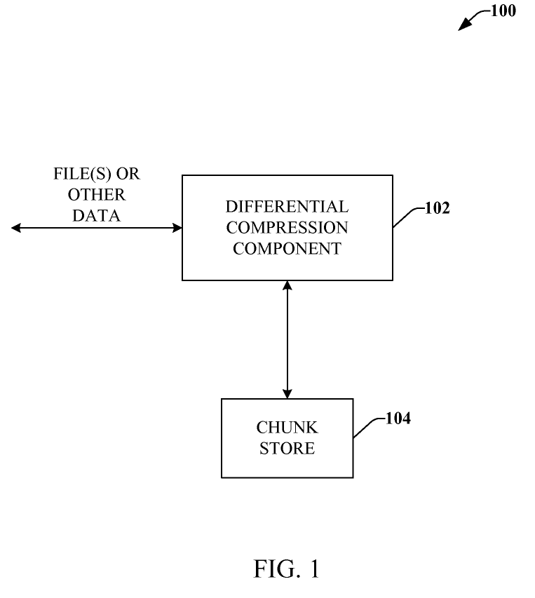

Now turning to the figures, FIG. 1 illustrates a system 100 that utilizes differential compression techniques in a distributed backup storage solution in accordance with various aspects. In one example, system 100 can be utilized to transfer, files, system images, and/or other data on a client machine to a data store (e.g., a chunk store), wherein the client machine and data store implement or are otherwise associated with system 100. In an aspect, the client machine can be a personal computer, a laptop computer, a server, a portable digital assistant (PDA), a mobile device, a smart phone, a cell phone, a portable gaming device, a media player or any other suitable computing device that can store, manipulate and/or transfer data.

In accordance with one aspect, system 100 can be utilized in connection with a network-based or online backup solution (e.g., a cloud backup system, as described in further detail infra) that stores backup information from a client machine at one or more remote storage locations on a network or internetwork to which the client machine is associated. Conventional online backup solutions operate by maintaining a set of files obtained from a backup client at a remote storage location. Subsequently, restoration is conducted by retrieving one or more files from storage locations as requested. As size of files, data collections, and client system grow, transfers of information from backup client in a backup solution such as a distributed backup solution, cloud backup solution, and/or a hybrid backup solution consume greater bandwidth. In addition, latency times associated with restoration can increase as larger portions of data are backed up (e.g., transferred between client and storage location).

To effectuate efficient transfer of information, system 100 can employ differential compression techniques to transmit files and/or other data to a storage location. In addition, differential compression techniques can be employed to recover or otherwise retrieve information from a storage location. In one example, differential compression mechanisms reduce bandwidth utilization and data transfer amounts by transferring differences between files instead of transmitting entire files. For instance, binary differential compression transfers differences between two versions of a file. However, the versions are known a priori. In another example, remote differential compression (RDC) can be utilized. RDC enables data to be synchronized between two nodes (e.g., a backup client and a storage location) through compression techniques that minimize data transfer across a network.

To provide efficient bandwidth utilization and reduce latency times, system 100 can facilitates differential storage and differential restoration of information. More particularly, when a user desires to store (e.g., backup) one or more files or other information (e.g., system images), a differential compression component 102 can be employed to conduct differential compression to reduce the size of data transfers to a chunk store 104. In accordance with an aspect, the differential compression component 102 can utilize a set of signatures and/or other indicators to determine only unique segments or blocks of the one or more files not previously stored at the chunk store 104.

In one aspect, the differential compression component 102 can utilize remote differential compression (RDC) to identify and transfer unique blocks of files or other information. With RDC, file similarity and/or file versioning need not be considered. The differential compression component 102 can identify differences on the fly in real-time. In one example, the differential compression component 102 can divide a file or other data into one or more chunks (e.g., segments, blocks, etc.). Splice points can be points in a file or other data that are boundaries between chunks and can be selected via a fingerprinting function. After dividing a file into chunks, the differential compression component 102 can generate a signature (e.g., a strong hash value) for each chunk. Signatures for each chunk can be included in a signature list of the file. The signature list can be utilized to compare contents of two arbitrarily different files. For instance, the signature list can be employed by the differential compression component 102 to ascertain if chunk store 104 already stores a particular chunk. Accordingly, the differential compression component 102 can identify unique chunks of a file or other information not stored in chunk store 104 such that a minimal amount of data is transferred to the chunk store 104.

In accordance with another aspect, the chunk store 104 can be a distributed network of storage locations such that chunks of data are stored across a plurality of nodes. The storage locations can include other client machines (e.g., personal computers, laptops, etc.), servers, content distribution networks, cloud storage locations, mobile devices, and/or any other suitable computing devices. Chunks associated with a file and/or several files can be distributed among storage locations included in the chunk store 104. In addition, chunks can be replicated across one or more storage locations to provide redundancy and maintain availability of chunks.

It is to be appreciated that system 100 can include any suitable and/or necessary interface components (not shown), which provides various adapters, connectors, channels, communication paths, etc. to integrate the differential compression component 102 into virtually any application, operating and/or database system(s). In addition, the interface components can provide various adapters, connectors, channels, communication paths, etc., that provide for interaction with and between the differential compression component 102, the chunk store 104, and/or component associated with system 100.

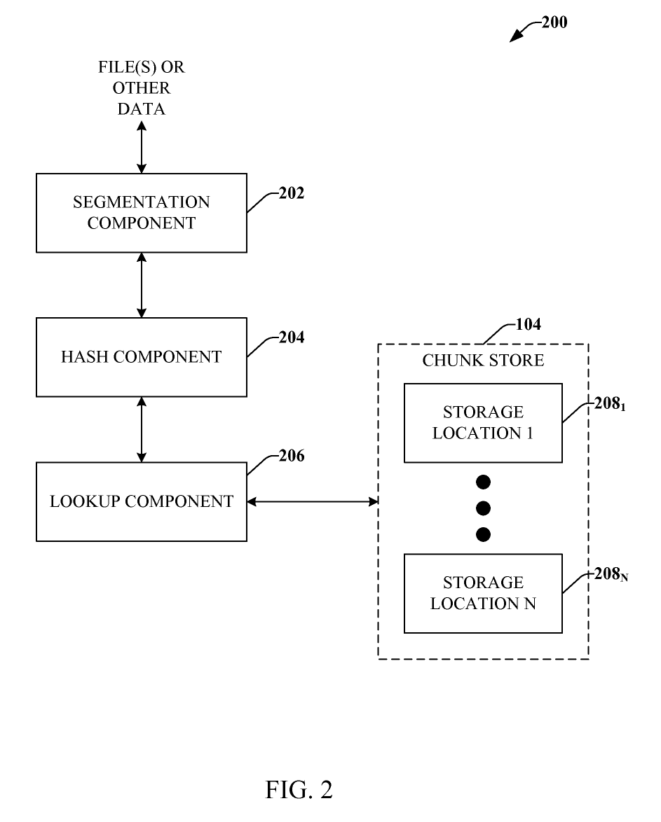

Turning now to FIG. 2, a system 200 for identifying chunks of a file or other data stored in a distributed data store in accordance with various aspects is illustrated. As FIG. 2 illustrates, system 200 can include a segmentation component 202 that divides file(s) or other data into one or more blocks (e.g., chunks). In one aspect, the segmentation component 202 can employ remote differential compression techniques to facilitate chunking of data. For instance, the segmentation component 202 can identify cut points in the files or other data that become boundaries between chunks. In one example, the segmentation component 202 can employ a fingerprint function to ascertain chunk boundaries. The fingerprint function can be utilized at each byte position of data. The fingerprint function can be a hash function that can be incrementally evaluated. For example, given a fingerprint value over a byte range, Bᵢ to Bⱼ, the fingerprint for Bᵢ₊₁ to Bⱼ₊₁ can be calculated by adding a fingerprint of byte Bⱼ₊₁ and subtracting a fingerprint of byte Bᵢ.

In an aspect, the segmentation component 202 can identify chunk boundaries to be byte positions at which the fingerprint function satisfies a condition. In accordance with an example, the condition can be a local maximum. A byte position can be a local maximum when a fingerprint value at that position is greater than a fingerprint value for the preceding h byte positions and the subsequent h positions, wherein h is an integer greater than or equal to zero. It is to be appreciated that h can be a configurable parameters. In addition, it is noted without limitation or loss of generality that other conditions can be employed to identify cut points or chunk boundaries.

Upon identification of cut points, the segmentation component 202 can divide the data (e.g., a file, system images, etc.) into chunks in accordance with the identified cut points. After segmentation, chunks can be provided to a hash component 204 that utilizes a hash function to generate a signature (e.g., a hash) for each chunk of data. The hash function utilized by the hash component 204 can be a cryptographically secure hash function (SHA). It is to be appreciated that other suitable collision-resistant hash functions can be utilized to generate signatures of chunks such as, for example, MD4.

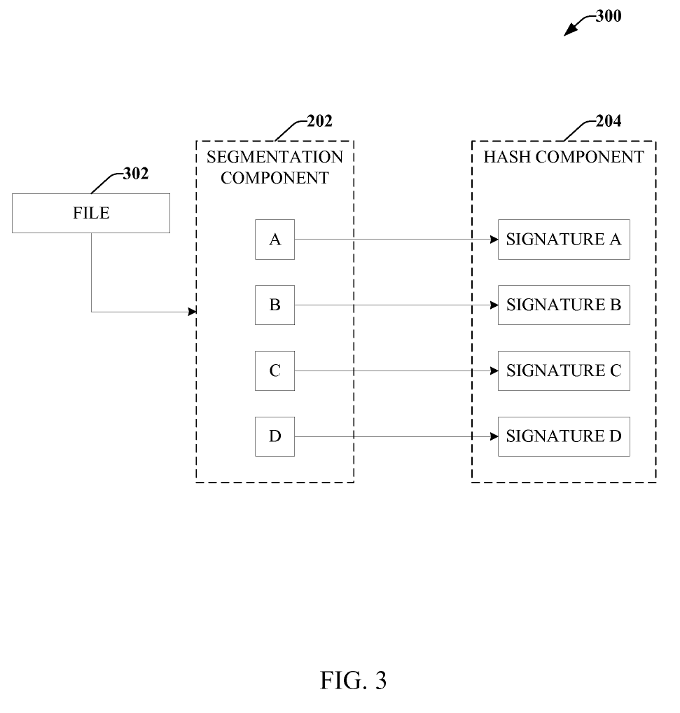

Turning briefly to FIG. 3, illustrated is a system 300 that generates a set of signatures from a file in accordance with one or more aspects. As depicted in FIG. 3, a file 302 can be divided into chunks by segmentation component 202. In one aspect, the segmentation component 202 can identify chunk boundaries at which to cut file 302 utilizing a fingerprint function as described previously. Although depicted in FIG. 3 to be segmented into four chunks, A-D, it is to be appreciated that segmentation component 202 can divide file 302 into fewer than four blocks or more than four blocks. Each chunk is conveyed to hash component 204 which generates a hash value or signature for each chunk respectively (e.g., signatures A-D as shown in FIG. 3).

Turning back to FIG. 2, signatures generated by the hash component 204 can be employed by a lookup component 206 to verify whether any chunks of data are stored in chunk store 104. In addition to signatures, the lookup component 206 can further utilize size or length of respective chunks to facilitate lookup of chunks stored by chunk store 104. In one example, the lookup component 206 can query an index, map, catalogue, or other suitable metadata associated with chunk store 104. The index can specify relationships between chunks, signatures of chunks, and corresponding storage locations associated with chunk store 104 to which chunks have been distributed. The index can be stored by a primary storage location of chunk store 104. In addition, the index can be distributed along with chunks of data represented therein to one or more storage locations 208 associated with chunk store 104. It is to be appreciated that an entire index can be distributed to one or more storage locations 208 (e.g., the index is replicated in its entirety), or that an index itself can be segmented and distributed among multiple locations. For instance, the index can be chunked, hashed and distributed in a manner similar to files or other data as described herein.

In accordance with another aspect, the chunk store 104 can include a plurality of storage locations 208 (e.g., depicted in FIG. 2 as storage locations 208₁ through 208_{N} where N is an integer greater than or equal to one). The storage locations 208 can include client machines such as, but not limited to, personal computers, mobile devices, laptop computers, PDAs, or other suitable computing devices. In addition, the storage locations 208 can further include servers (e.g., enterprise servers, home servers, etc.), content distribution networks, and so on. It is to be appreciated that storage locations 208 can also include one or more cloud storage locations. Cloud storage locations can include any collection of resources (e.g., hardware, software, combination thereof, etc.) that are maintained by a party (e.g, off-site, on-site, third party, etc.) and accessible by an identified user over a network (e.g., Internet, wireless, LAN, cellular, WiFi, WAN, etc.). For instance, users can access, join and/or interact with cloud storage locations (e.g, via cloud backup service offered by an entity) and, in turn, store data (e.g., backup information and/or chunks thereof) at the cloud storage locations which provide cheap storage with high availability.

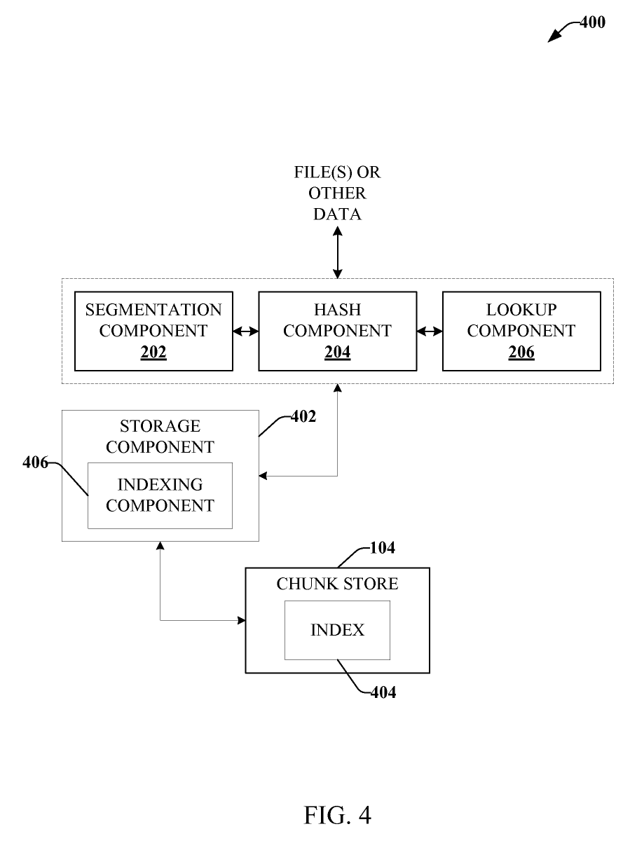

FIG. 4 illustrates a system 400 that transfers unique portions of a file or other data to a distributed data store in accordance with one or more aspects. System 400 can include a segmentation component 202, hash component 204, and lookup component 206 that can perform substantially similar functions are described supra with respect to FIG. 2. For example, the segmentation component 202 can analyze files or other data to identify cut points therein. Cut points are boundaries between chunks of the files or other data such that the segmentation component 202 can divide the files or other data into blocks (e.g., chunks, segments, etc.) at the cut points. In one example, the segmentation component 202 can employ a fingerprint function on the files or other data to identify cut points. A signature can be generated for each block by the hash component 204. The lookup component 206 can employ an index (e.g., index 404) to verify if a given block is stored in chunk store 104 based at least in part on a signature of the block.

In accordance with one aspect, the lookup component 206 can ascertain that a given block is not stored by the chunk store 104. For example, the lookup component 206 can query index 404 associated with chunk store 104 with a signature and/or length of a block. The lookup component 206 can declare a block to be absent from chunk store 104 when the query does not return a result (e.g., a chunk) matching the query (e.g., signature and/or length of a block).

System 400 includes a storage component 402 that facilitates transferring a unique block (e.g., a block not stored in chunk store 104) to the chunk store 104. As discussed supra with reference to FIG. 2, the chunk store 104 can be a distributed storage system that includes a plurality of storage locations. In accordance with one aspect, a hybrid peer-to-peer (P2P) and cloud based architecture can be utilized by system 400. The chunk store 104 can include one or more storage locations such as one or more trusted peer(s) and/or super-peer(s), as well as one or more cloud storage locations. To facilitate redistribution of blocks among storage locations in chunk store 104, peer(s), super-peer(s), and/or cloud storage locations can communicate chunks or other backup information between each other. In addition, it can be appreciated that segmentation component 202, hash component 204, lookup component 206, and/or any other components of system 400 could additionally be associated with one or more storage locations associated with chunk store 104. Further detail regarding techniques by which peer(s), super-peer(s), and cloud storage locations can be utilized, as well as further detail regarding the function of such entities within a hybrid architecture, is provided infra.

In an aspect, the storage component 402 that manages locality of chunks in distributed chunk store 104. In one example, the storage component 402 can distribute chunks of backup data among storage locations in chunk store 104 such that availability and optimal locality is maintained while reducing storage costs, bandwidth costs, and latency times upon restoration. The storage component 402 can evaluate characteristics of storage locations in chunk store 104 and distribute chunks of backup data accordingly. The characteristics can include availability of storage locations (e.g., based on device activity levels, powered-on or powered-off status, etc.), available storage space at locations, cost of storage at locations, cost of data transfer to/from locations, network locality of locations (e.g., network topology), and the like. In one example, the storage component 402 can distribute more chunks of backup data to storage locations with higher storage capability and availability than to other storage locations (e.g., normal client machines).

In accordance with another aspect, storage component 402 can include and/or otherwise be associated with an indexing component 406, which can maintain an index 404 that lists relationships between blocks of backup data and storage locations of chunk store 104 to which the blocks have been distributed. In one example, the indexing component 406 can add, delete, and/or modify entries in the index when the storage component 402 renders distribution and/or replication decisions regarding blocks. In another example, the index 404 can be distributed along with blocks of backup data represented therein to one or more storage locations of chunk store 104. It is to be noted without limitation or loss of generality that an entire index can be replicated and stored at one or more locations, or that an index can be divided and distributed, in chunks, among multiple locations. In another aspect, the index 404 can include metadata such as signatures of blocks stored by the chunk store 104.

In accordance with another aspect, the lookup component 206 can ascertain that a given block is stored by the chunk store 104. For example, the lookup component 206 can query index 404 associated with chunk store 104 with a signature and/or length of a block. The lookup component 206 can declare a block to be present in chunk store 104 when the query returns a result (e.g., a chunk and/or the chunk's storage location) matching the query (e.g., signature and/or length of a block). In one example, a reference count can be utilized to indicate a number of client machines that point to a particular chunk in chunk store 104. When a client machine processing a file or other data to be backed up and generates a chunk already stored in chunk store 104, the client machine can increase a reference count associated with the chunk. The reference count can be included in index 404. To reduce orphan chunks (e.g., block of backup data not referenced by any clients), garbage collection mechanism can operate on chunk store 104 to remove floating blocks.

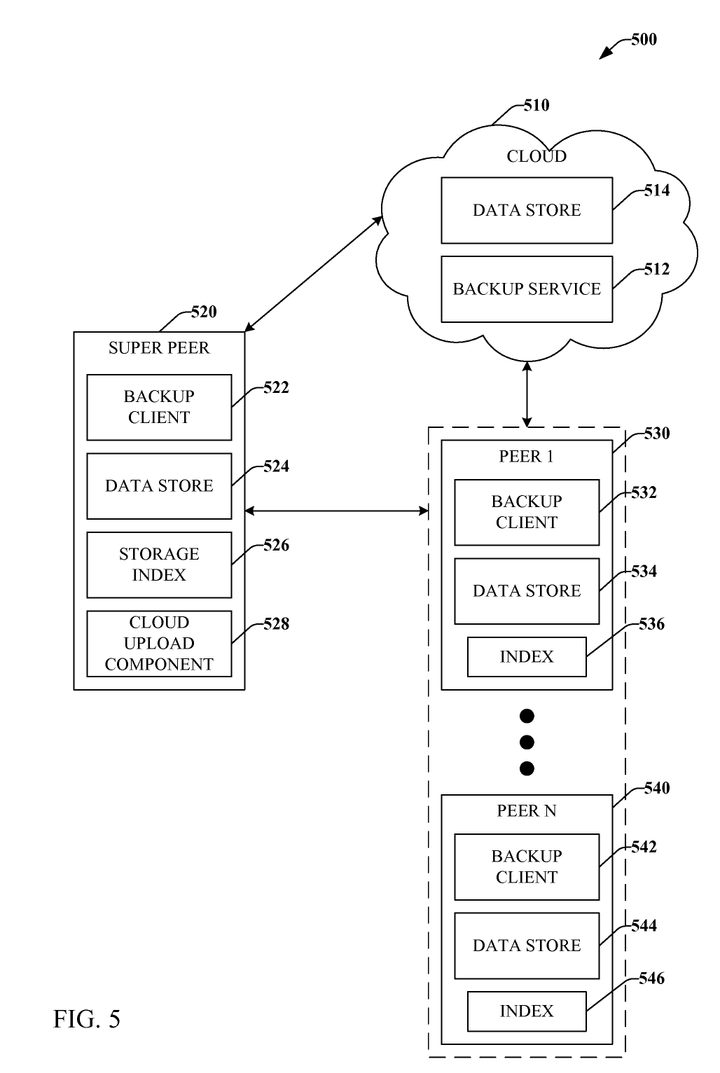

Referring next to FIG. 5, illustrated is a system 500 that implements hybrid cloud-based and peer-to-peer backup storage in accordance with various aspects. As system 500 illustrates, a network implementation can utilize a hybrid peer-to-peer and cloud-based structure, wherein a cloud 510 interacts with one or more super peers 520 and one or more peers 530-540.

In accordance with one aspect, cloud 510 can be utilized to remotely implement one or more computing services from a given location on a network/internetwork associated with super peer(s) 520 and/or peer(s) 530-540 (e.g., the Internet). Cloud 510 can originate from one location, or alternatively cloud 510 can be implemented as a distributed Internet-based service provider. In one example, cloud 510 can be utilized to provide backup functionality to one or more peers 520-540 associated with cloud 510. Accordingly, cloud 510 can implement a backup service 512 and/or provide associated data store 514.

In one example, data storage 514 can interact with a backup client 522 at super peer 520 and/or backup clients 532 or 542 at respective peers 530 or 540 to serve as a central storage location for data residing at the respective peer entities 520-540. In this manner, cloud 510, through data storage 514, can effectively serve as an online “safe-deposit box” for data located at peers 520-540. It can be appreciated that backup can be conducted for any suitable type(s) of information, such as files (e.g., documents, photos, audio, video, etc.), system information, and/or chunks of files or system information. Additionally or alternatively, distributed network storage can be implemented, such that super peer 520 and/or peers 530-540 are also configured to include respective data storage 524, 534, and/or 544 for backup data associated with one or more machines on the associated local network. In another example, techniques such as de-duplication, incremental storage, and/or other suitable techniques can be utilized to reduce the amount of storage space required by data storage 514, 524, 534, and/or 544 at one or more corresponding entities in the network represented in FIG. 5 for implementing a cloud-based backup service.

In accordance with another aspect, cloud 510 can interact with one or more peer machines 520, 530, and/or 540. As illustrated in FIG. 5, one or more peers 520 can be designated as a super peer and can serve as a liaison between cloud 510 and one or more other peers 530-540 in an associated local network. It is to be appreciated that any suitable peer 530 and/or 540, as well as designated super peer(s) 520, can directly interact with cloud 510 as deemed appropriate. Thus, it can be appreciated that cloud 510, super peer(s) 520, and/or peers 530 or 540 can communicate with each other at any suitable time to synchronize files or other information between the respective entities associated with system 500.

In one example, super peer 520 can be a central entity on a network associated with peers 520-540, such as a content distribution network (CDN), an enterprise server, a home server, and/or any other suitable computing device(s) determined to have the capability for acting as a super peer in the manners described herein. In addition to standard peer functionality, super peer(s) 520 can be responsible for collecting, distributing, and/or indexing data among peers 520-540 in the local network. For example, super peer 520 can maintain a storage index 526, which can include the identities of respective files and/or file segments corresponding to peers 520-540 as well as pointer(s) to respective location(s) in the network and/or in cloud data storage 514 where the files or segments thereof can be found. The storage index 536 can also include reference counts of particular data segments (e.g., chunks), wherein a reference count indicates a number of clients that point to a respective segment. Although shown in FIG. 5 to be associated with super-peer 520, it is to be appreciated that the storage index 526 can be managed by cloud 510, peers 530-540, and/or distributed among super peer 520, cloud 510 and peers 530-540. For instance, peers 530 and 540 can include respective indexes 536 and 546 which can include a local cache of at least a portion of storage index 526. Additionally or alternatively, super peer 520 can act as a gateway between other peers 530-540 and a cloud service provider 510 by, for example, uploading respective data to the cloud service provider 510 at designated off-peak periods via a cloud upload component 528. However, peers 530-540 can additionally communicate information directly to cloud service provider 510.

It is to be appreciated that the data stores illustrated in system 500 (e.g., data stores 514, 524, 534, and 544) can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data stores can be a server, a database, a hard drive, a pen drive, an external hard drive, a portable hard drive, and the like.

In accordance with an aspect, data stores 514, 524, 534, and 544 associated respectively with could 510, super peer 520, and peers 530-540 can implement a distributed chunk store such as chunk store 104 described herein. For instance, data stores 514, 524, 534, and 544 can store blocks of backup information generated via differential compression techniques such as remote differential compression. In addition, backup clients 522, 532, and 542 as well as backup service 512 can utilize hashes or signatures of chunks to determine unique blocks to transfer. In accordance with an example, peer 530 can include a file to be backed up to the hybrid architecture depicted in FIG. 5. The backup client 532 associated with peer 530 can segment the file into chunks and apply a hash function to each chunk to generate respective signatures. The backup client 532 can utilize the signatures to query an index such as storage index 526 to determine which chunks, if any, are already stored in a chunk store (e.g., data stores 514, 524, 534, and 544). Unique chunks (e.g., chunks not already stored) can be distributed across cloud 510, super peer 520, and/or peers 530-540.

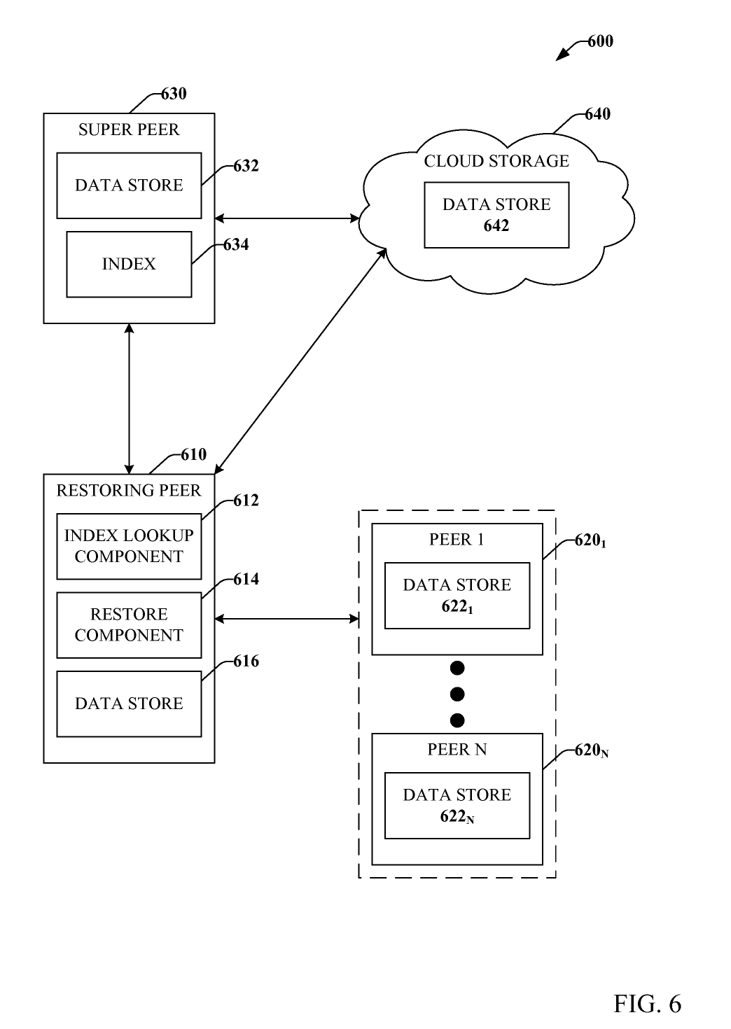

Referring now to FIG. 6, illustrated is a system 600 that facilitates conducting a differential restore in a hybrid cloud-based and peer-to-peer backup architecture in accordance with various aspects. As system 600 illustrates, a hybrid P2P/cloud backup architecture can be utilized, wherein backup information corresponding to one or more computing devices is distributed among one or more peers machines 610 or 620 and/or one or more super-peer machines 630, as well as one or more cloud storage locations 640.

In one example, peer machines 620 can include respective data stores 622, which can be utilized to receive and maintain backup information corresponding to one or more files, system images, or other information. Backup information stored in data stores 622 can be associated with, for example, a restoring peer 610. The backup information can include chunks of files or other data generated by the restoring peer 610 (or another device) via remote differential compression, for example. In addition, the restoring peer 610 can additionally or alternatively include a data store 616 for locally storing backup information (or chunks thereof) corresponding to files, versions of files, system images, and the like, residing locally at restoring peer 610.

In another example, one or more super peers 630 in system 600 can additionally include a data store 632 as well as an index 634, which can provide a master listing of blocks of backup information stored within system 600 and their respective locations. Although index 634 is illustrated as located at super peer 630 in system 600, it should be appreciated that some or all of index 634 could additionally or alternatively be located at one or more peers 610 and/or 620 as well as at cloud storage 640.

In accordance with one aspect, the restoring peer 610 can include a restore component 614 that can issue a restore request. The restore request can be a request to roll-back a version of file retained by the restoring peer 610 with a previous version distributed in system 600. In another example, the restore request can be a command to recover a version (e.g., a most recent version, an original version and/or any version therebetween). An index lookup component 612 can obtain metadata from index 634 and/or any other suitable source that points to the respective locations of file versions to be restored.

Based on the locations obtained by index lookup component 612, the restore component 614 can pull blocks of backup information from their corresponding locations within data store(s) 622, 632, 642, and/or any other suitable storage location within system 600. Accordingly, in one example, a restore can be conducted by pulling incremental delta chunks necessary to recreate a desired version. In another example, a complete rendition of the desired version can be located and obtained.

In accordance with another example, the hybrid P2P/cloud backup architecture of system 600 can be exploited to minimize latency and/or bandwidth required to restore one or more file versions at a restoring peer 610. For example, restore component 614 can analyze system 600 to facilitate pulling of respective blocks from the path of least resistance through system 600. Thus, for example, in the event that a given block resides at data store 622 or 632 at a peer 620 or super peer 630 as well as in cloud storage 640, preference can be given to pulling the block from the nearest network nodes first. As a result, a peer 620 and/or super peer 630 can be prioritized over cloud storage 640 to minimize the latency and bandwidth usage associated with communicating with cloud storage 640. In addition, restore component 614 can analyze availability of respective nodes in system 600, relative network loading and/or other factors to facilitate intelligent selection of nodes from which to obtain file versions. Accordingly, the restoring peer 610 can be configured to first attempt to obtain blocks from a peer machine 620 or a super peer 630, falling back on cloud storage 640 only if no peers 620 and/or 630 with required file versions are available. In an alternative example, super peer 630 and/or another entity from which the restoring peer 610 accesses index 634 can utilize similar network analysis in order to select an optimal location from among a plurality of locations that retains a block as indicated by the index 634. Once selected, such location(s) can be subsequently provided to a restoring peer 610.

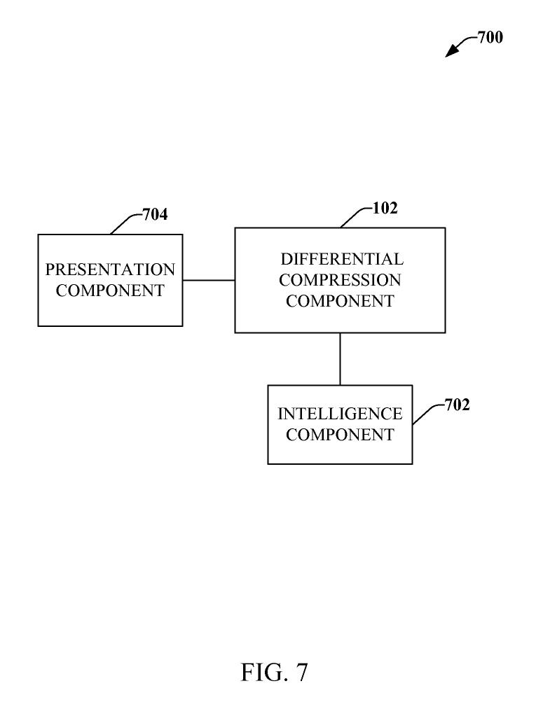

FIG. 7 illustrates a system 700 that facilitates differential transfer and storage of data in a distributed data store in accordance with various aspects. The system 700 can include the differential compression component 102 which can be substantially similar to respective components, boxes, systems and interfaces described in previous figures. The system 700 further includes an intelligence component 702. The intelligence component 602 can be utilized by the differential compression component 102 to infer, for example, segmentation of a file, a location of a file chunk, an optimal distribution of chunks, a level of redundancy of a chunk, and the like.

The intelligence component 702 can employ value of information (VOI) computation in order to identify appropriate peers to identify optimal allocations of backup data amongst peers and to identify candidate backup data for shifting to cloud storage. For instance, by utilizing VOI computation, the most ideal and/or appropriate super peer designations and/or backup data allocations can be determined. Moreover, it is to be understood that the intelligence component 702 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The differential compression component 102 can further utilize a presentation component 704 that provides various types of user interfaces to facilitate interaction between a user and any component coupled to system 700 (e.g., backup clients, backup service, etc.). As depicted, the presentation component 704 is a separate entity that can be utilized with the differential compression component 102. However, it is to be appreciated that the presentation component 704 and/or similar view components can be incorporated into the differential compression component 102 and/or a stand-alone unit. The presentation component 704 can provide one or more graphical user interfaces (GUIs), command line interfaces, and the like. For example, a GUI can be rendered that provides a user with a region or means to load, import, read, edit etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

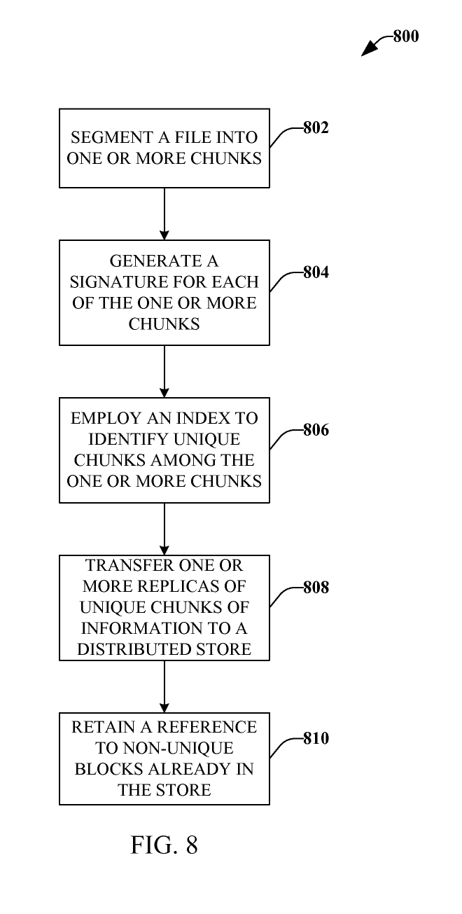

FIG. 8 illustrates a methodology and/or flow diagram in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 8, a method 800 for performing differential transfers of backup information in a backup system is illustrated. The method 800 can be employed, for example, by a backup client to reduce bandwidth utilized to backup information to a hybrid peer-to-peer/cloud backup solution. At reference numeral 802, a file is segmented into one or more chunks. For example, a fingerprint function (e.g., a hash) can be employed over a range of bytes of the file (e.g., a hash window) and computed over the range for each byte position of the file. A cut point or chunk boundary can be identified as a byte position at which the fingerprint function is a local maximum. The file can be segmented along identified cut points.

At reference numeral 804, a signature can be generated for each of the one or more chunks of the file. The signature can be generated by a cryptographically secure hash and/or any other suitable collision-resistant operation. At reference numeral 806, an index can be employed to identify unique chunks among the one or more chunks. In one example, the index can be maintained by a distributed chunk store that retains chunks of data in a distributed fashion across a plurality of storage locations. The index can include signatures of chunks retained in the chunk store. A signature of a file chunk can be looked up in the index to determine whether the chunk is already stored. A unique chunk can be a chunk of information that is not already retained by the chunk store.

At reference numeral 808, one or more replicas of unique chunks of information can be transferred to a distributed store (e.g., a chunk store). It is to be appreciated that, once transferred, unique chunks can be added to an index such that other clients can avoid transferring duplicate chunks. At reference numeral 810, a reference to non-unique chunks can be retained. The reference can be a reference count included in metadata (e.g., the index) that indicates a particular client possesses interest in a particular chunk. For example, the chunk can be a chunk necessary to restore a file, system images, or other data.

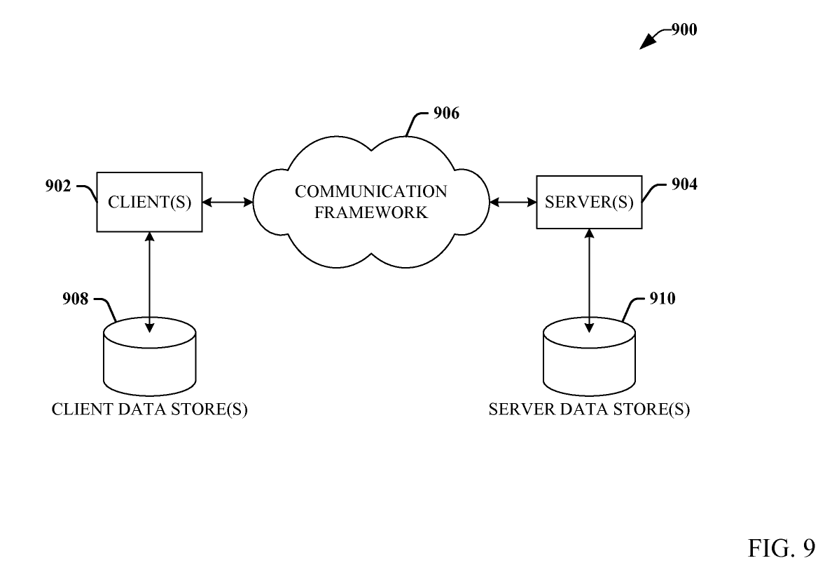

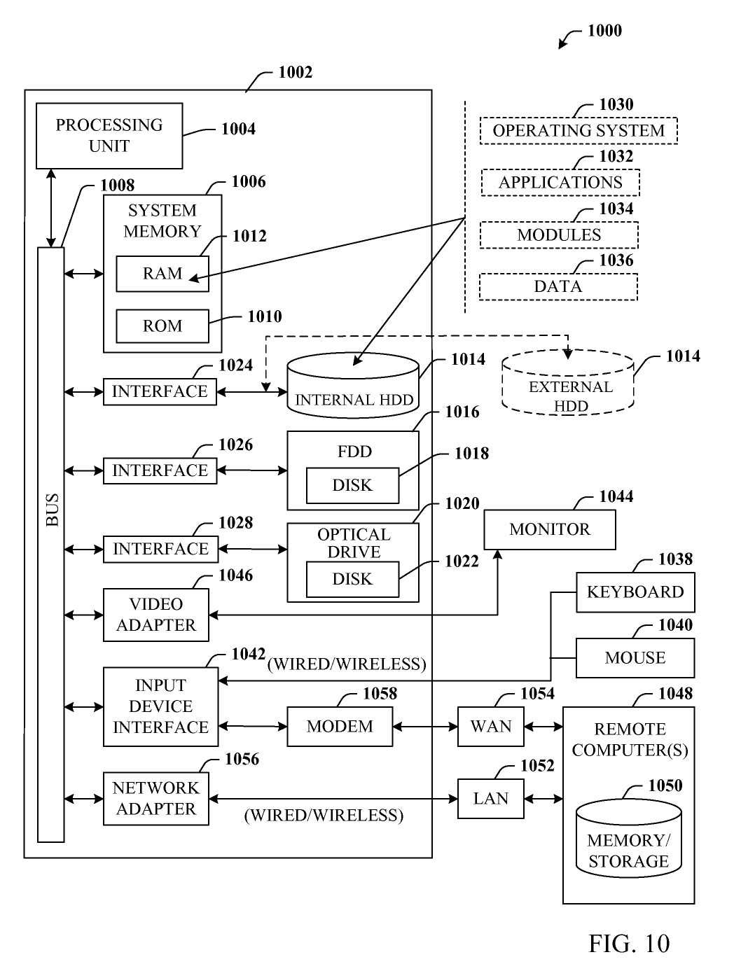

In order to provide additional context for implementing various aspects of the claimed subject matter, FIGS. 9-10 and the following discussion is intended to provide a brief, general description of a suitable computing environment in which the various aspects of the subject innovation may be implemented. For example, client machines such as peers and super-peers, as well as cloud storage locations can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Referring now to FIG. 9, there is illustrated a schematic block diagram of an exemplary computer compilation system operable to execute the disclosed architecture. The system 900 includes one or more client(s) 902. The client(s) 902 can be hardware and/or software (e.g., threads, processes, computing devices). In one example, the client(s) 902 can house cookie(s) and/or associated contextual information by employing one or more features described herein.

The system 900 also includes one or more server(s) 904. The server(s) 904 can also be hardware and/or software (e.g., threads, processes, computing devices). In one example, the servers 904 can house threads to perform transformations by employing one or more features described herein. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

With reference to FIG. 10, an exemplary environment 1000 for implementing various aspects described herein includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10BaseT wired Ethernet network.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates differential transfer of data in a backup system, comprising:
a processor coupled to a memory that retains computer-executable instructions, the processor executes:
a differential compression component that segments a portion of information into one or more blocks and generates respective signatures for each of the one or more blocks, the differential compression component identifies unique blocks from the one or more blocks based at least in part on the generated signatures and signatures of chunks stored in a distributed chunk store; and
a storage component that transfers identified unique blocks of the portion of information to the distributed chunk store.

2. The system of claim 1, further comprising a segmentation component that employs a fingerprint function to identify boundaries between the one or more blocks of the portion of information.

3. The system of claim 2, wherein boundaries are byte positions corresponding to local maxima of the fingerprint function.

4. The system of claim 1, further comprising a hash component that utilizes a hash function to generate signatures for each of the one or more blocks.

5. The system of claim 4, wherein the hash function is a cryptographically secure hash function.

6. The system of claim 1, further comprising an index lookup component that queries an index associated with the distributed chunk store to identify which of the one or more blocks are stored.

7. The system of claim 6, wherein the index lookup component queries the index with the generated signatures to determine if blocks with matching signatures is stored by the distributed chunk store.

8. The system of claim 7, wherein the storage component transfers blocks corresponding to non-matching signatures to the distributed chunk store.

9. The system of claim 1, wherein the differential compression component increases a reference count to a non-unique block stored in the distributed chunk store that corresponds to at least one of the one or more blocks of the portion of information.

10. The system of claim 1, wherein the storage component includes an indexing component that maintains an index, the indexing component at least one of adds, deletes, or modifies entries in the index when blocks are transferred by the storage component.

11. The system of claim 10, wherein the index comprises a listing of relationships between blocks stored in the distributed chunk store and signatures of the blocks.

12. The system of claim 1, wherein the distributed chunk store includes a set of storage locations.

13. The system of claim 12, wherein the set of storage locations include one or more of peers or cloud storage locations.

14. The system of claim 1, wherein the differential compression component employs remote differential compression.

15. A method for differentially storing and transferring backup information in a distributed backup environment, comprising:
employing a processor executing computer-executable instructions stored on a computer-readable storage medium to implement the following acts:
querying an index associated with a distributed chunk store with a set of signatures, the set of signatures correspond to a respective set of segments of a portion of backup information;
identifying unique segments from the set of segments based at least in part on results of the query; and
transferring the identified unique segments to the distributed chunk store.

16. The method of claim 15, further comprising utilizing a fingerprint function on the portion of backup information to identify cut points at which to segment the portion of backup information.

17. The method of claim 16, wherein the cut points are byte positions at which the fingerprint is a local maximum over a window.

18. The method of claim 15, further comprising employing a hash function one each segment in the set of segments to generate the respective set of signatures.

19. The method of claim 15, wherein the distribute chunk store includes a plurality of storage locations, the plurality of storage locations include one or more peer machines or cloud storage locations.

20. A system that facilitates differential transfer and storage of backup data in a backup environment, comprising:
at least one processor that executes computer-executable code stored in memory to effect the following:
means for segmenting a portion of backup data into a set of chunks, the means for segmenting divides the portion of backup data along boundary points identified with a fingerprint function;
means for generating a set of signatures corresponding to the set of chunks, the means for generating employs a hash function on each chunk in the set of chunks to create a respective signature;
means for querying a distribute chunk store with the set of signatures to identify unique chunks in the set of chunks, wherein a unique chunk is a block of backup data absent from the distributed chunk store; and
means for transferring unique chunks to the distributed chunk store.
